(19) United States
(12) Patent Application Publication
(10) Pub. No.: US 2010/0004375 A1
(43) Pub. Date: Jan. 7, 2010

(54) IMPACT MODIFIED POLYPHENYLENE SULFIDE

(75) Inventors: Basker R. Lalgudi, Chadds Form, PA (US); Sean A. Arsenault, Philadelphia, PA (US); Gregory S. O'Brien, Downingtown, PA (US)

Correspondence Address: ARKEMA INC.;PATENT DEPARTMENT - 26TH FLOOR, 2000 MARKET STREET, PHILADELPHIA, PA, 19103-3222, US

(73) Assignee: Arkema Inc., Philadelphia, PA (US)

(21) Appl. No.: 12/166,627

(22) Filed: Jul. 2, 2008

(51) Int. Cl. C08L 81/04; C08L 53/00

(52) U.S. Cl. 524/502; 525/189; 525/92 A

(57) ABSTRACT

The invention relates to a process for improving the impact resistance of polyphenylene sulfide (PPS) using a functional polyolefin and an elastomer, in which the functional polyolefin and elastomer are pre-compounded prior to combination with the PPS. The pre-compounding of the PPS additives prior to addition of the additives to the PPS provides a composition having vastly improved impact and strain at break properties. Especially useful functional polyolefins are LOTADER resins (Arkema Inc.) and especially useful elastomers are PEBAX resins (Arkema Inc.).

### FIELD OF THE INVENTION

The invention relates to a process for improving the impact resistance of polyphenylene sulfide (PPS) using a functional polyolefin and an elastomer, in which the functional polyolefin and elastomer are pre-compounded prior to combination with the PPS. The pre-compounding of the PPS additives prior to addition of the additives to the PPS provides a composition having vastly improved impact and strain at break properties. Especially useful functional polyolefins are LOTADER resins (Arkema Inc.) and especially useful elastomers are PEBAX resins (Arkema Inc.).

### BACKGROUND OF THE INVENTION

Polyphenylene sulfide (PPS) is a useful engineering plastic having a high heat resistance, but it suffers from poor impact resistance. The PPS chain is known for being relatively inactive, having a poor affinity for elastomers. The impact resistance can be improved through the use of an epoxy functional alpha-olefin copolymer—however this results in an increase in melt viscosity causing problems in the moldability and flexibility of the PPS composition.

U.S. Pat. No. 5,654,358 discloses a PPS composition having good impact properties, and which overcomes the problems of the increased viscosity. The PPS composition is a combination of PPS, a copolymer of an alpha-olefin with a glycidyl ester of an alpha, beta-unsaturated acid, and one of several specific elastomers. The components are all dry-blended together, then melt-kneaded and pelletized. While the improvement in strain at break and impact resistance is improved over unmodified PPS, the composition doe not meet the requirements for many applications.

A problem with modified PPS, is that many elastomers are incompatible with PPS, and therefore do not produce a homogenous blend. A compatibilizer, like a glycidyl ester functionalized alpha-olefin copolymer, can be used to more homogeneous blend. However, dry blending of the components, as taught in the art, does not produce the intimate association required for optimal compatiblization and best impact resistance.

Surprisingly, it has now been found that the impact resistance of PPS compositions can be significantly improved by pre-compounding the elastomer and functional olefin, prior to the addition of the additives to the PPS.

### SUMMARY OF THE INVENTION

The invention relates to a process for forming a polyphenyl sulfide (PPS) composition comprising the steps of:
a) heat-compounding a functional polyolefin and an elastomer; and
b) admixing said compounded functional olefin/impact modifier composition with polyphenyl sulfide to form a polyphenyl sulfide composition, wherein the polyphenyl sulfide comprises at least 60 weight percent of said admixture.

The invention also relates to article formed from the compounded PPS.

### DETAILED DESCRIPTION OF THE INVENTION

The invention relates to a process for significantly improving the impact resistance of a PPS composition by pre-blending a functionalized olefin, and elastomer prior to adding the blended components to the PPS.

Polyphenylene sulfide (PPS) polymers of the present invention are those having a relatively low molecular weight, and prepared by known processes, such as that disclosed in U.S. Pat. No. 3,354,129; and those having relatively high molecular weight, prepared by known processes, such as that disclosed in U.S. Pat. No. 3,919,177. The PPS my be linear or branched. Substantially linear PPS, having a relatively high molecular weight is preferred in applications requiring the toughness of the higher molecular weight PPS.

While the type of PPS used in the invention is not limited to any type of PPS, that having a low level of ionic species is preferred as it has a higher affinity for the olefinic copolymer of the invention. Low ionic species level can be controlled by any use or combination of polymerization techniques, selection of raw materials, or post-treatment of the polymers by a deionizing purification and/or washing, as known in the art, to reduce the sodium content.

The functional polyolefin of the invention is a functionalized alpha-olefin. Preferably the functionalized is epoxy groups or dicarboxylic acid anhydrides like maleic anhydride. The functionalization can be in the main polymer chain, or in the side chains. The olefin polymer is preferably ethylene, propylene or n-butylene, or a mixture thereof.

The epoxy groups may conveniently be added by copolymerization of the olefin with an epoxy-containing monomer, such as a glycidyl ester of an ethylenicallly unsaturated (meth)acrylic acid. Preferred epoxy-containing monomers include, but are not limited to, glycidyl acrylate and glycidyl methacrylate. The epoxy group may also be added by post-polymerization functionalization.

Anhydrides of polydicarboxylic acids include, but are not limited to, maleic anhydride, and fumaric anhydride The functional olefinic copolymer preferably contains from 0.1 to 30 weight percent, and more preferably from 0.5 to 10 weight percent functionality.

The functionalized olefin is present in the PPS at from 1 to 30 weight percent, and preferably from 2 to 10 percent by weight.

In addition to the functional olefin, at least one elastomeric impact modifier is added to the composition. The impact modifier is present in the PPS at from 1 to 30, and preferably from 2 to 10 percent by weight. The ratio of the impact modifier to the functionalized olefin is from 75:25 to 25:75 and preferably from 40:60 to 60:40 by weight.

The elastomer of the present invention is preferably a poly(ether block amide) or poly(ester block amide), and most preferably a poly(ether block amide). Other elastomers also useful in the invention include, but are not limited to copolymers of ethylene/propylene, ethylene/butane, ethylene/propylene/diene, styrene/butadiene/styrene, and ethylene/(meth)acrylic acid. Specially preferred elastomers are poly(ether block amide) copolymers, such as those sold under the PEBAX trademark from Arkema.

Other additive can be present in the composition at levels typical in the art, and can be added into one of the components, such as the PPS, prior to admixing with the other components of the invention, or can be added during or after the admixing of components of the invention. Useful additives include, but are not limited to, heat stabilizers, dyes, colorants, antioxidants, lubricants, UV absorbers and fibrous or granular reinforces.

The key to the improvement in properties of the compositions of the present invention is that the impact modifier and functional olefin are heat-compounded prior to being added to the PPS. The heat compounding involves the combination of the components in the melt state under conditions of heat, pressure and shear. Heat compounding can occur by any method known in the art. In one embodiment, the elastomer and functional olefin are melt blend extruded into homogeneous pellets. In an extrusion process, one preferred embodiment is the use of a twin screw extruded, though single screw and other arrangements can also produce adequate compounding. The melt compounding has the advantage over dry blending in that the components are more intimately associated.

The melt-compounded functional olefin and elastomer are then combined with PPS. The PPS can be in the powder form, but preferably are in a compounded pellet form. The compounded PPS pellets may contain the optional other additives. The PPS and compounded elastomer/functional olefin may be combined in a manner known in the art, preferably in a melt-blending—such as, for example, in an extrusion process or blow-molding process. The PPS is present at rater than 60 weight percent of the final composition, preferably at greater than 75 weight percent, and in one embodiment at greater than 85 weight percent.

The composition of Applicant's invention, in which the functional olefin and elastomer are pre-compounded, prior to compounding with PPS shows an increase in strain at break of 948% over the unmodified PPS, compared to only 515% when the components are added without the pre-compounding step. The impact strength at 23° C. for the composition of the invention showed an increase of 648% over the unmodified PPS, while the modified composition made by the process of the prior art showed only a 261% increase in impact. Other mechanical properties of the composition also are improved, including multiaxial impact, and tensile strength.

The modified PPS composition of the invention can be used in many applications, especially those having high heat requirements. The PPS composition is generally formed into objects by heat processing, including, but not limited to, injection molding, extrusion molding, and blow molding. Some of the uses for the compounded PPS include, but are not limited to: automotive under-hood parts, automotive fuel lines, switches and brushes, electrical fittings, thermal devices, appliance motor parts, computer parts, fax gears and guards, pumps and housings. Other uses exist in, for example, aerospace, military, recreational vehicle, electronics, and electrical applications.

### EXAMPLES

### Example 1

### Comparative—Unmodified PPS

A sample of unfilled PPS (FORTRON 0320, Ticona) was used without modification. The PPS was dried for 3 hours at 110° C. The FORTRON 0320 was melt extruded through a WP-30 with a melt temperature of 338° C. and a process pressure of 120-150 phi, and a feed rate of 15 lbs/hr. The white FORTRON 0320 powder turned into a dark yellow opaque color when pelletized.

### Example 2

### Comparative—Co-blending of Ingredients—No Compounding

20 pounds of PEBAX 3533 (polyester block amide, Arkema) was dry-blended with 20 pounds of LOTADER AX8900 (reactive polyethylene having glycidyl methacrylate functionality, Arkema) for 20 minutes by the drum-tumbling technique.

19.8 pounds of pelletized FORTRON 0320 was dry blended with 2.2 pounds of the dry-blended PEBAX/LOTADER powder for 20 minutes by drum tumbling. The blend was then melt extruded through a WP-30 with a melt temperature of 210° C. at a screw speed of 172 rpm and a process pressure of 360-400 phi, a vacuum of −19″ Hg, and a feed rate of 25 lbs/hr.

The compounded pellets were dried for 6 hours at 60° C.

### Example 3

### (Of The Invention) Pre-Compound Functional Olefin and Impact Modifier

20 pounds of PEBAX 3533 was dry-blended with 20 pounds of LOTADER AX8900 for 20 minutes by drum tumbling. The blend was then melt extruded through a WP-30 with a melt temperature of 210° C. at a screw speed of 172 rpm and a process pressure of 360-400 psi, a vacuum of −19″ Hg, and a feed rate of 25 lbs/hr. 19.8 pounds of pelletized PPS was dry-blended with 2.2 pounds of the melt-compounded PEBAX 3533/LOTADER AX8900 blend for 20 minutes by drum-tumbling. The blend was then melt extruded through a WP-30 with a melt temperature of 313° C. at a screw speed of 200 rpm and a process pressure of 460-480 psi, and a feed rate of 30 lbs/hr. The compounded pellets were dried overnight at 60° C. The final PPS/PEBAX/LOTADER pellets returned to a white color.

### Example 4

Each of the pelletized materials from Examples 1-3 was separately injection molded, using a twin screw injection molder with a mold temperature of 150° C. and a pressure of 700 psi for the compositions of Examples 2 and 3, and a pressure of 575 psi for the PPS of Example 1. The pellets of Example 1 were difficult to injection mold. The injected molded parts (plaques and bar for tensile testing) were tested for Tensile Modulus by ASTM D638 (average of 5 samples), Flexual modulus by ASTM D790 (average of 5 samples), Strain at break by ASTM-D638 (average of 5 samples), and notched I-Zod impact strength at 23° C. by ASTM-D256 (average of 10 samples). The results are shown in Table 1.

TABLE 1

| | | | | Notched |
|---|---|---|---|---|
| | Tensile | Flexual | Strain | I-Zod, J/M) |
| | Modulus, psi | Modulus, psi | at break, % | @ 23° |
| Ex. 1 (Comp) | 500,087 | 455,215 | 3.12 | 30.20 |
| Ex. 2 (Comp) | 428,057 | 375,558 | 19.2 | 109.0 |
| Ex 3 | 397,330 | 364,406 | 32.5 | 226.0 |

What is claimed is:

1. A process for forming a polyphenyl sulfide (PPS) composition comprising the steps of:
a) heat-compounding a functional polyolefin and an elastomer; and
b) admixing said compounded functional olefin/impact modifier composition with polyphenyl sulfide to form a polyphenyl sulfide composition, wherein the polyphenyl sulfide comprises at least 60 weight percent of said admixture.

2. The process of claim 1, wherein said polyphenyl sulfide composition is further melt-processed into an article.

3. The process of claim 2, wherein said melt-processing comprises injection molding, extrusion molding, or blow-molding.

4. The process of claim 1, wherein said PPS has been de-ionized prior to admixing in step (b).

5. The process of claim 1, wherein said functional polyolefin comprises an ethylene, propylene or butylene functional copolymer.

6. The process of claim 1, wherein said functional polyolefin is a copolymer comprising 0.1 to 30 weight percent of glycidyl (meth)acrylate units and/or maleic anhydride units.

7. The process of claim 1, wherein said elastomer comprises a polyether block polyamide or a polyester block polyamide.

8. The process of claim 1, wherein said elastomer comprises a polyether block polyamide.

9. The process of claim 1, wherein said composition further comprises one or more additives selected from the group consisting of heat stabilizers, dyes, colorants, antioxidants, lubricants, UV absorbers, and fibrous or granular reinforcers.

10. The process of claim 1, wherein the ratio of functional polyolefin to elastomeric impact modifier is from 25:75 to 75:25 percent by weight.

11. The process of claim 1, wherein the ratio of functional polyolefin and elastomeric impact modifier to PPS is from 40:60 to 60:40 percent by weight.

12. The process of claim 1 wherein said PPS comprises at least 85 weight percent of the polyphenyl sulfide composition.

13. The process of claim 1, wherein said impact modifier is present in the composition at from 2 to 10 weight percent, based on the weight of the PPS.

14. The process of claim 1, wherein said elastomer is present in the composition at from 2 to 10 weight percent, based on the weight of the PPS.

15. The process of claim 2, wherein said article comprises an automotive under-hood parts, automotive fuel lines, switches and brushes, electrical fittings, thermal devices, appliance motor parts, computer parts, fax gears and guards, pumps. housings. aerospace article, military article, recreational vehicle, electronics, and electrical applications.
